(19) United States
(12) Patent Application Publication
(10) Pub. No.: US 2010/0000829 A1
(43) Pub. Date: Jan. 7, 2010

(54) SHAFT BEARING ASSEMBLY

(76) Inventor: Hubert Koschinat, Hosbach (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/496,210

(22) Filed: Jul. 1, 2009

(30) Foreign Application Priority Data
Jul. 3, 2008 (DE) 10 2008 031 489.7

(51) Int. Cl. F16D 65/58

(52) U.S. Cl. 188/196 V

(57) ABSTRACT

A shaft bearing assembly for a brake assembly includes a cam shaft having a bearing section and a cam, a brake anchor plate having a bearing eye which receives the cam shaft at the bearing section, a slack adjuster assembly operably coupled to the cam shaft, and an elastic bearing element radially prestressed and operably coupled to the bearing section of the cam shaft in a torsion-elastic manner such that after a predetermined twist angle of the cam shaft is attained, the cam shaft slips through relative the bearing element during a braking action.

### BACKGROUND OF THE INVENTION

The present invention relates to a shaft bearing assembly, and in particular, to a shaft bearing assembly for the activation of a drum brake for vehicles.

### SUMMARY OF THE INVENTION

One aspect of the present invention includes a shaft bearing assembly for activating a drum brake assembly of a vehicle, including a cam shaft having a bearing section, a brake anchor plate having a bearing eye receiving the cam shaft at the bearing section, a cam operably coupled to and activated by the cam shaft, a slack adjuster assembly operably coupled to the cam shaft, and an elastic bearing element radially prestressed and operably coupled to the bearing section of the cam shaft in a torsion-elastic manner such that after a predetermined twist angle of the cam shaft is attained, the cam shaft slips through relative the bearing element during a braking action.

Yet another aspect of the present invention includes, a shaft bearing assembly for activating a drum brake assembly of a vehicle, including a cam shaft having a bearing section, a brake anchor plate having a bearing eye which is operably coupled to the cam shaft at the bearing section, a cam operably coupled to and activated by the cam shaft, a slack adjuster assembly operably coupled to the cam shaft, and an elastic bearing element radially prestressed and operably coupled to the bearing section of the cam shaft in a torsion-elastic manner having a return moment bearing on the cam shaft which negates the need a return spring to return the cam shaft to its resting position after a braking action.

These and other features, advantages and objects of the present invention will be further understood and appreciated by those skilled in the art upon studying the following specification, claims, and appended drawings.

### BRIEF DESCRIPTION OF THE DRAWINGS

The present invention will now be described, by way of example, with reference to the accompanying drawings, in which:

FIG. 1 is a partial top fragmentary view of one embodiment of a shaft bearing assembly of the present invention;

FIG. 2 is a partial top fragmentary view of another embodiment of a shaft bearing assembly of the present invention;

FIG. 3 is a partial top fragmentary view of yet another embodiment of a shaft bearing assembly of the present invention;

FIG. 4 is a partial top fragmentary view of yet another embodiment of a shaft bearing assembly of the present invention;

FIG. 5 is a partial top fragmentary view of a slack adjuster assembly of the present invention.

### DETAILED DESCRIPTION OF PREFERRED EMBODIMENTS

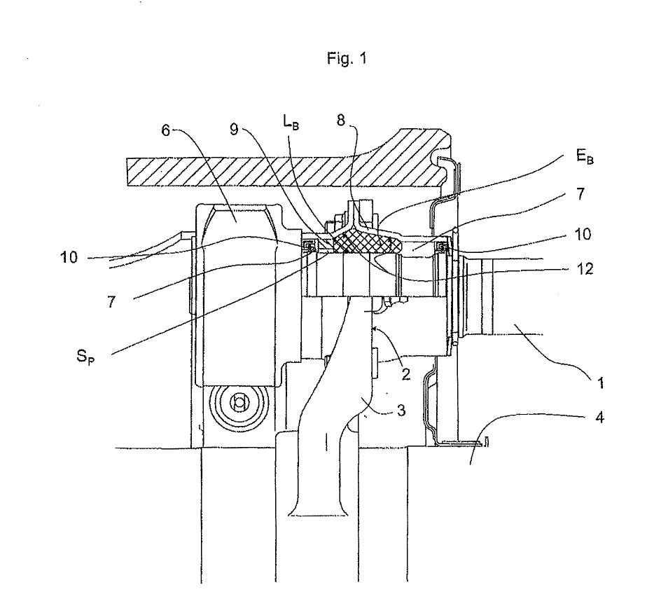

For purposes of description herein, the terms “upper,” “lower,” “right,” “left,” “rear,” “front,” “vertical”, “horizontal” and derivatives thereof shall relate to the shaft bearing assembly as oriented in FIG. 1. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

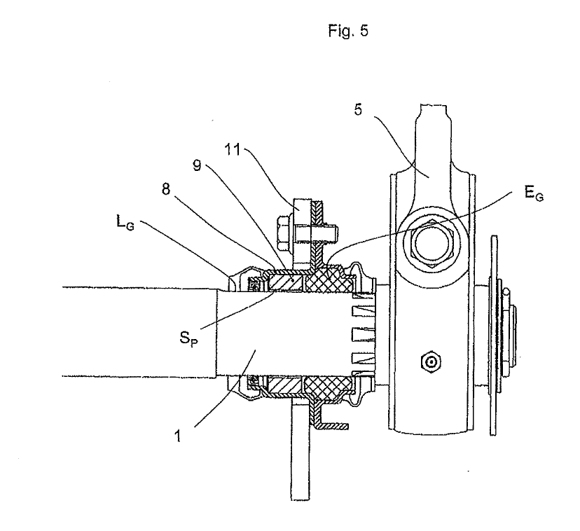

As shown in FIG. 1, a shaft bearing assembly includes a cam shaft 1 which is rotatably received via a bearing section L_{B} in a bearing eye 2 of a brake anchor plate 3 which is held axially immoveable and is secured to a vehicle at the vehicle's axle body 4. Adjacent the bearing section L_{B}, the cam shaft 1 is operably coupled to a cam 6, such as an S-shaped cam 6 (FIG. 1), wherein the cam 6 engages and activates a drum brake (not shown) of a vehicle during a braking action. At the opposite end of the cam shaft 1 relative to the brake anchor plate 3, the cam shaft 1 is operably coupled to a slack adjuster assembly 5 (FIG. 5).

The shaft bearing assembly further includes at least one bearing element E_{G} disposed on the side of the cam shaft 1 where cam shaft 1 engages the brake anchor plate 3. The bearing element E_{G} is generally made of permanent elastic material and is radially prestressed in torsion-elastic manner on the bearing section L_{B} of the cam shaft 1. The radial prestressing of the bearing element E_{G} is designed such that the bearing element E_{G} does not sit slip-free on the bearing section L_{B} of the cam shaft 1. Similarly, the cam shaft 1 does not slip through relative to the bearing element E_{G} from the start of the brake activation, as this would cancel the restoring moment of the cam shaft 1 too quickly. Instead, the prestressing of the bearing element E_{G} is attuned to achieve a deliberate slip through of the cam shaft 1 only after a predetermined twist angle (e.g., after a twist of 10-40 degrees or at least 25 degrees), of the cam shaft 1 is attained. In this way, the vehicle driver can make sure that a radial sliding adjustment between cam shaft 1 and the elastic material of the bearing element E_{G} takes place only after the cam shaft 1 has achieved a twist angle great enough to activate the automatic slack adjuster 5 such that the automatic slack adjuster 5 has readjusted at least once during the braking action.

The elastic bearing element E_{G} is generally configured as a sleeve that wraps around the cam shaft 1 at the bearing section L_{B} as shown in FIG. 1. In its uninstalled condition (not shown), the elastic bearing element E_{G} has an inner diameter which is slightly smaller than the outer diameter of the cam shaft 1 in the region of the bearing section L_{B}. Thus, the bearing element E_{G} already exerts a certain radial prestressing on the cam shaft 1 after installation.

Alternatively, to facilitate the installation of the bearing element E_{G}, the inner diameter of the bearing element E_{G} can be equal to or slightly larger than the outer diameter of the cam shaft 1 in the region of the bearing section L_{B} and the bearing element E_{G} can be adjustably braced to the desired degree on the bearing section L_{B}.

The elastic bearing element E_{G} is generally contained in a stationary housing 8 and joined to this housing 8 free of torsion. As shown in FIG. 1, the housing 8 can be a two-part housing where the two parts have conical housing shapes on the inside. When the two housing parts are joined together, the elastic bearing element E_{B} can be braced against the bearing section L_{B} of the cam shaft 1. Further, the elastic bearing element E_{B} can be braced against the bearing section L_{B} by means of at least one conical housing shape of at least one part of the housing 8, so that the desired radial prestressing is easily achieved. Moreover, in order to facilitate the adjustment of the radial prestressing, the elastic bearing element E_{B} may be profiled on its inner surface adjacent to the bearing section L_{B}.

During heavy deceleration or full braking it may be necessary to prevent a large deflection of the cam shaft 1 in order to avoid overloading the permanent elastic material of the bearing element E_{B}. For this purpose, a rigid path limiter 9, of a bush type as shown in FIG. 1, is provided preferably at least on one side of the elastic bearing element next to the elastic bearing element E_{B} in the region of the bearing section L_{B} for limiting the radial deflection or play S_{P} of the cam shaft 1 to approximately 1 mm to 3 mm. In assembly, the path limiter 9 can be secured to the stationary housing 8 of the shaft bearing assembly.

In order to ensure largely unaltered conditions for the desired slip through of the cam shaft 1 during a braking event relative to the bearing element E_{B}, the surface of the bearing section L_{B} can be coated with an anticorrosion agent in order to protect the bearing section L_{B} from corrosion and prevent changes in the frictional conditions between the bearing section L_{B} and the bearing element E_{B}.

It is an object of the shaft bearing assembly of the present invention to be largely maintenance-free. In an effort to retain the same reliable frictional conditions over the full lifetime of the shaft bearing assembly, a grease chamber 7 may be disposed at least on one side of the elastic bearing element E_{B}. The grease chamber 7 can be closed off by an external sealing element, such as a radial shaft seal 10. As shown in FIG. 1, sealing elements 10, configured as radial shaft seals, are located at both ends of the housing 8 so that inwardly closed grease chambers 7 are formed.

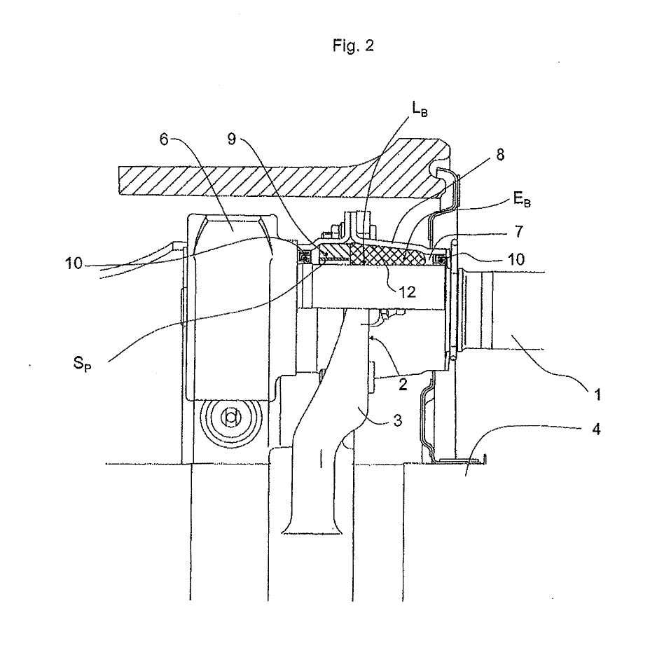

The shaft bearing assembly of FIG. 1 is configured as an interchangeable bearing unit which can be mounted on the bearing section L_{G} of the cam shaft 1. In the embodiment shown in FIG. 2, the alternative shaft bearing assembly has an enlarged bearing section L_{B} as compared to the embodiment shown in FIG. 1. Here, the bearing element E_{B} is located inside one half of the housing 8, which is configured slightly conical on the inside so that when the two halves of the housing 8 are joined together, the elastic bearing element E_{B} comes to bear against the path limiter 9 and is prestressed in the desired manner with respect to the bearing section L_{B}. The path limiter 9 is secured in the other half of the housing 8 which, consequently, need not be conical in shape.

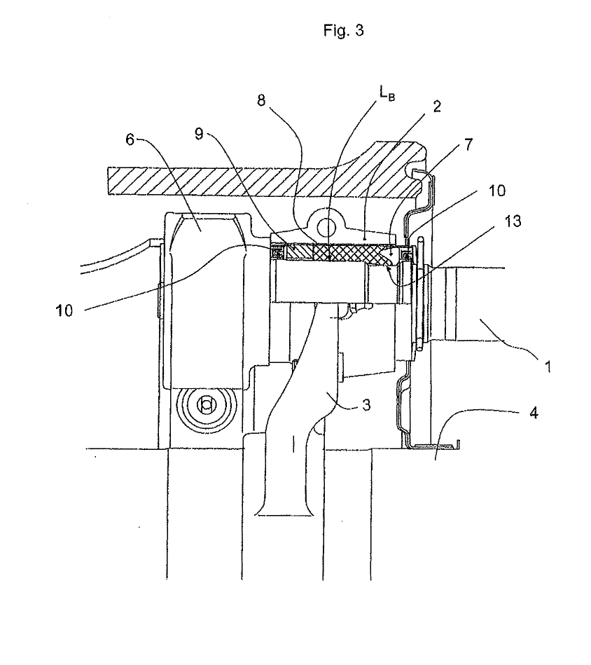

As shown in FIG. 3, another alternative shaft bearing assembly of the present invention includes a cam shaft 1 received in a forged-on bearing eye 2 of a brake anchor plate 3. In this case, a cylindrical housing 8 encloses an elastic bearing element E_{B} provided on one side of the housing 8 with a sealing lip 13 used to bound off a grease chamber 7.

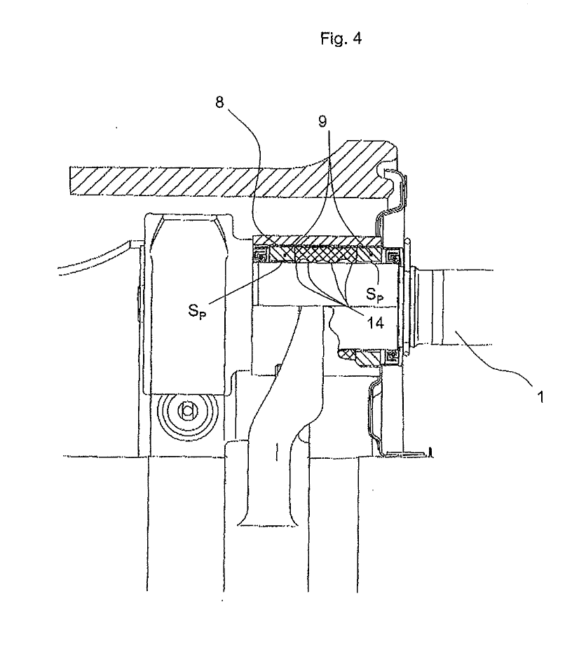

As shown in FIG. 4, yet another alternative shaft bearing assembly according to the present invention is depicted wherein an elastic bearing element E_{B} is provided with a concave profiling having indentations 14 on its inner surface by which it lies against a bearing section L_{B}. In this case, path limiters 9 are secured on both sides of the elastic bearing element E_{B} to create a radial play S_{P} on the inside of a sleeve-like housing 8. The bearing is received in a forged-on bearing eye 2 of a brake anchor plate 3, which is clamped on the inside.

Referring now to FIG. 5, a shaft bearing mechanism 100D according to the present invention is depicted in the region of an automatic slack adjuster 5 of the cam shaft 1, which sits prestressed in a bearing element E_{B} via a bearing section 18. The shaft bearing mechanism as illustrated in FIG. 5 is designed similar to the shaft bearing mechanism of FIG. 1 located in the region of the brake anchor plate 3. In this configuration, when the cam shaft 1 is prestressed on both ends in this way by two separate elastic bearing elements E_{B} (FIG. 1) and E_{G} (FIG. 5), the restoring forces of elastic bearing elements E_{B}, E_{G} acting in concert are large enough so that the otherwise usual return spring for restoring the cam shaft 1 back to its starting position after a braking event can be eliminated.

The above description is considered that of the preferred embodiments only. Modifications of the invention will occur to those skilled in the art and to those who make or use the invention. Therefore, it is understood that the embodiments shown in the drawings and described above is merely for illustrative purposes and not intended to limit the scope of the invention, which is defined by the following claims as interpreted according to the principles of patent law, including the Doctrine of Equivalents.

The invention claimed is:

1. A shaft bearing mechanism for activating a drum brake assembly of a vehicle, comprising:
a cam shaft operably coupled to a cam and having a bearing section;
a brake anchor plate having a bearing eye receiving the cam shaft at the bearing section;
a slack adjuster assembly operably coupled to the cam shaft; and
an elastic bearing element radially prestressed and operably coupled to the bearing section of the cam shaft in a torsion-elastic manner such that the cam shaft slips through relative the bearing element after a predetermined twist angle of the cam shaft is attained during activation of the brake assembly.

2. The shaft bearing mechanism of claim 1, wherein the twist angle is equal to an angle of turn of the cam shaft required in a braking process plus at least an angle required to activate the slack adjuster.

3. The shaft bearing mechanism of claim 1, further comprising:
a path limiter disposed on at least one side of the elastic bearing element and is adapted to limit movement of the cam shaft in a radial direction.

4. The shaft bearing mechanism of claim 1, wherein the cam shaft includes an outer diameter at the bearing section, and the bearing element includes an inner diameter that is less than or equal to the outer diameter of the cam shaft.

5. The shaft bearing mechanism of claim 1, wherein the bearing element has an inner diameter equal to or greater than an outer diameter of the cam shaft at the bearing section.

6. The shaft bearing mechanism of claim 1, further including:
a housing surrounding at least a portion of the bearing element, wherein the housing braces the bearing element at the bearing section.

7. The shaft bearing mechanism of claim 6, wherein the housing includes a conical shape at the bearing section.

8. The shaft bearing mechanism of claim 1, wherein the cam shaft is coated with an anticorrosion agent at the bearing section.

9. The shaft bearing mechanism of claim 1, further comprising:
a sealed grease chamber disposed on at least one side of the bearing element.

10. The shaft bearing mechanism of claim 9, wherein the sealed grease chamber is sealed with a radial shaft seal.

11. The shaft bearing mechanism of claim 1, wherein the bearing element includes an irregular inner surface.

12. The shaft bearing mechanism of claim 1, further including:
a first bearing positioned proximate the slack adjuster; and
a second bearing similar in construction to the first bearing and positioned proximate the brake anchor plate.

13. The staff bearing mechanism of claim 1, wherein the bearing element is radially prestressed such that the bearing element returns the cam shaft to a pre-braking position.

14. A shaft bearing mechanism for activating a drum brake assembly of a vehicle, comprising:
a cam shaft operably coupled to a cam and having a bearing section;
a brake anchor plate having a bearing eye which is operable coupled to the cam shaft at the bearing section;
a slack adjuster assembly operably coupled to the cam shaft;
an elastic bearing element radially prestressed and operably coupled to the bearing section of the cam shaft in a torsion-elastic manner, and having a return moment bearing on the cam shaft when the cam shaft is rotated during activation of the brake assembly.
